(19) United States
(12) Patent Application Publication
(10) Pub. No.: US 2024/0302171 A1
(43) Pub. Date: Sep. 12, 2024

(54) AUTO-DIRECTING AUDITING SYSTEM

(71) Applicant: HF investment Ltd., Taichung City (TW)

(72) Inventor: CHIEN-HAO LEE, Taichung City (TW)

(21) Appl. No.: 18/522,837

(22) Filed: Nov. 29, 2023

(30) Foreign Application Priority Data
Mar. 8, 2023 (TW) 112108515

(51) Int. Cl. G01C 21/20; G06Q 30/018

(52) U.S. Cl. CPC G01C 21/206; G06Q 30/018

(57) ABSTRACT

An auto-directing auditing system operated by a mobile device, containing the following steps: a server loads a map, wherein the map corresponds to a site awaiting auditing; the mobile device obtains a current location and marks said current location on corresponding position on the map; the server loads multiple nodes awaiting auditing in the site and marks the nodes on the map; the server loads multiple historical records and multiple attributes of the nodes in the server; and an inspection route is determined and generated based on audit requirements, wherein the inspection route passes through each node awaiting audit on the map.

### FIELD OF INVENTION

The present invention relates generally to an auditing system, and particularly to an automatic auditing system that actively helps auditors get auditing instructions.

### BACKGROUND OF THE INVENTION

The operations of a company must comply with various regulations and standards, and it must also make efforts to fulfill its responsibilities as a social enterprise. This includes creating a working environment that prioritizes sustainable operations, safe working environment, fairness, and health for shareholders, employees, customers, suppliers, and society as a whole. To demonstrate that a company can indeed meet certain legal (such as environmental protection, fire safety, occupational safety, etc.) or regulatory (such as ISO quality systems) requirements in its operation, it is necessary for modern businesses to regularly and periodically dispatch personnel to conduct audits and verifications. This is an important investment in the operation of a business. However, these verification tasks are often very time-consuming, requiring excessive resources. These tasks can be more challenging due to changes in the target area of verification, making the verification process and recording difficult. Poor record-keeping can also lead to issues of repeated inspections.

### SUMMARY OF THE INVENTION

To solve abovementioned problems, this present invention discloses an auto-directing auditing system operated by a mobile device, comprising the following steps: a server loads a map, wherein the map corresponds to a site awaiting auditing; the mobile device obtains a current location and marks said current location on corresponding position on the map; the server loads multiple nodes awaiting auditing in the site and marks the nodes on the map; the server loads multiple historical records and multiple attributes of the nodes in the server; and an inspection route is determined and generated based on audit requirements, wherein the inspection route passes through each node awaiting audit on the map.

Wherein, the map is a three-dimensional map.

Wherein, at least one of the nodes comprises a status report module in connection with the server, wherein the status report module establishes a connection with the mobile device when the mobile device is in proximity and the status report module updates the real-time location of the mobile device on the map.

Wherein, the mobile device generates a message based on whether the attributes satisfy a set of predefined conditions.

Wherein, the set of predefined conditions comprises a last inspection date.

Wherein, the mobile device obtains a geographic orientation of a user and compares the geographic orientation with the geographic orientation of the site, and a directional icon is displayed on the map, overlapping with the inspection route, wherein the directional icon indicates the orientation along the inspection route.

### BRIEF DESCRIPTION OF THE DRAWINGS

FIG. 1 is a schematic diagram of a preferred embodiment of a network of a system in accordance with this invention;

FIG. 2 is a schematic diagram of a preferred embodiment of a system in accordance with this invention; and

FIG. 3 is a diagram of a preferred embodiment of a site for inspection.

### DETAILED DESCRIPTION OF THE PREFERRED EMBODIMENTS

In order to make purposes, technical solutions, and advantages of the present invention to be clearer, the following content provides some preferred embodiments in accordance with the present invention.

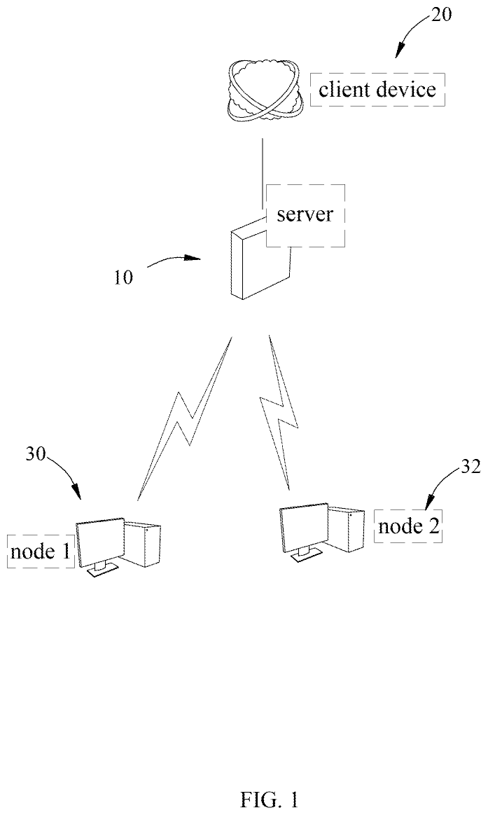

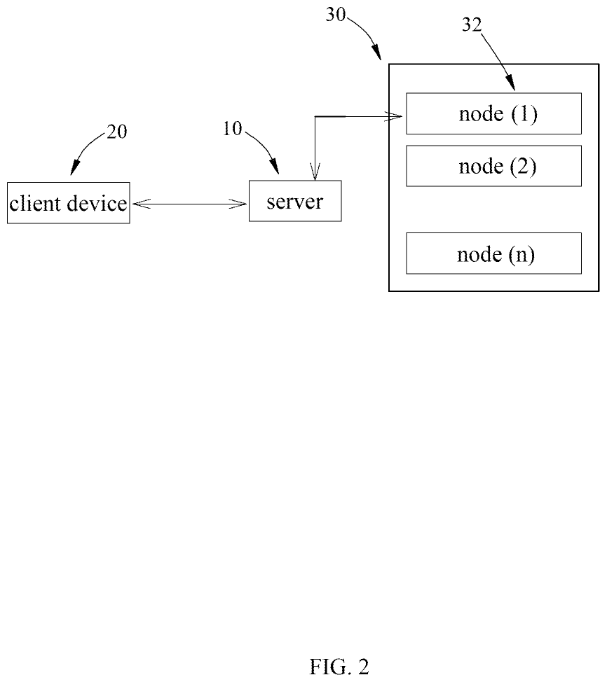

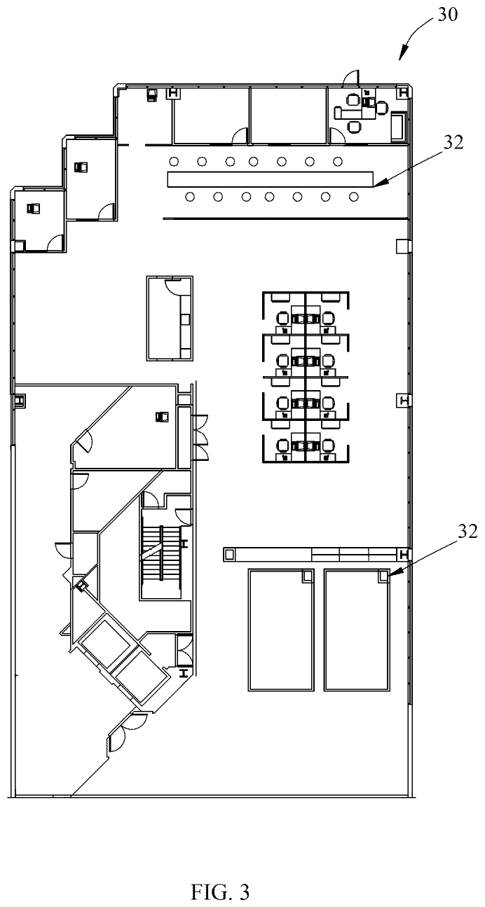

With reference to FIG. 1 to FIG. 3, a preferred embodiment of an auto-directing auditing system of this invention comprises a server 10, a client device 20, and several nodes 32. The server 10 can be a cloud server that communicates with the client device 20 and the nodes through cloud services (i.e., internet services); the nodes 32 are scattered over a site 30. The site 30 is an area of verification, and the site 30 can be a plant, a room, an office building, or a factory, etc. Each node 32 corresponds to an item that needs to be verified on the site 30 for inspection. The type of item corresponding to each node 32 is not limited. For example, the type of item may include fire facilities that should comply with fire regulations such as fire extinguishers, hydrants, or fire escape equipments. In some preferred embodiments, to verify and measure the carbon emissions of an organization (ISO14064-1:2018), the node 32 can represent an item such as an air conditioning unit, a boiler, an automobile, a power system, a motor, a steam equipment, a production machinery, a water heater, and the like.

The server 10 generates a map corresponding to each of the site 30. The map can be a two-dimensional or three-dimensional map. In the present embodiment, a three-dimensional (3D) map is preferred. The nodes 32 in this embodiment are distributed throughout the site 30 according to fire safety, ISO, and other objectives. Attributes of the node 32 in the site 30 is continuously recorded. Said attributes can be different information based on the differences in verification points. For instance, the attributes can be inspection histories, inspection dates, specifications, and the like.

Furthermore, in the present embodiment, the server 10 can generate an verification checklist that records all the nodes 32 and their corresponding attributes, as shown in table 1 below:

TABLE 1

| Node(s) | Attribute(s) | Location(s) |
|---|---|---|
| Emergency exit | a. Legal compliance | 1F, X1, Y1 |
| | b. Specifications and status | |
| | c. Latest verification date | |
| Fire distinguisher | a. Types and specifications | 2FR1, X1, Y1 |
| | b. Expiration date | |
| | c. Latest verification date | |
| Boiler | a. Types and specifications | 1FR1, X1, Y1 |
| | b. Expiration date | |
| | c. Latest verification date | |

As shown in table 1 above, the verification checklist can list all the nodes 32 according to different verification criteria, and record the attributes and location of each said node 32 in the same verification checklist. The location corresponding to the nodes 32 in Table 1 are marked on the map.

Furthermore, in a preferred embodiment, every said node 32 contains a status report module. The status report module includes a location report unit, an image report module, and/or a functional report unit. The location report unit can be a positioning unit or a wireless transmission unit, such as an indoor positioning unit. In addition to recording its corresponding location on the map, the location report unit can establish a signal connection with the user's client device 20. The location report unit reports the location of the nodes 32 and the distance between the nodes 32 and the user's client device 20 to the server 10. For example, the location report unit can be a Bluetooth unit. When the user's client device 20 comes in close proximity, the location report unit establishes a pairing connection with the client device 20 and instantly reports to the server 10 that the client device 20 is near the nodes 32. The server 10 can then retrieve and send back to the client device 20 relevant information, such as the inventory list and attributes associated with the nodes 32. The image report unit captures real-time streaming images or photographs of the nodes 32 and sends them to the server 10. These images can be associated with and updated in the inventory list. The functional report unit records and reports the working conditions and status of the nodes 32. The working conditions and status are related to the device types and inspection priorities of the nodes 32. For example, it can output data such as voltage, current, thermal energy output, real-time temperature, carbon dioxide emissions, gas flow rate, etc., based on different device types. If the nodes 32 are monitoring specific dimensions or functionalities, the working conditions and status can include spatial dimensions, distance, and more. In such cases, the functional report unit could be an instant size measurement device, such as a microwave or infrared distance measurement device, or an object detection device. The functional report unit would report the measurements or detection results to the server 10.

The user's client device 20, preferably a mobile device, such as a smartphone or a tablet, can connect to the server 10 wirelessly to receive the map, the inventory list, locations and attributes of the nodes 32, and other relevant information from the server 10. The user's client device 20 executes inspection or verification by establishing a connection with the server 10 and obtaining the map and the inventory list. This inspection or verification can be implemented as a mobile application running on the user's client device 20.

The aforementioned inspection/verification method includes the following steps:
Step 1: Loading the map. The application is installed on the client device. The application requests the server 10 to load the map corresponding to the site 30 for inspection.
Step 2: Real-time location identification. The client device 20 obtains the current location by using GPS data of the mobile device. Alternatively, the client device 20 can establish a connection with a wireless receiver located at the site 30. By determining the physical location of the wireless receiver, which could be positioned at the entrance, specific areas, or throughout the entire site 30, the client device 20 can determine its actual location within the site 30. Once connected to the wireless receiver, the client device 20 retrieves the physical location information either from the receiver itself or from the server 10, thereby identifying its real-time position.
Step 3-A: Mark nodes for inspection and verification. The server 10 marks the position of each inspection node 32 on the map and optionally loads corresponding attributes of the node 32. The server 10 can then generate the locations of the nodes 32 for inspection and verification on the map and display them with the attributes of the nodes 32.
Step 3-B: Load the verification checklist and marking the nodes for inspection or verification. After the client device 20 has loaded the map, the client device 20 can optionally request the server 10 to load the verification checklist corresponding to the site 30. The verification checklist contains the positions and the attributes of all or selected inspection nodes 32 within the site 30. The client device 20 can then mark these inspection nodes 32 on the map based on the verification checklist, as shown in Table 1.
Step 3-C: Automatic update inspection/verification results: The client device 20 can optionally perform a remote automatic update of the inspection/verification results. Each inspection node 32 can be equipped with one or more said status report modules to obtain real-time status reports and send the reports to the server 10. This allows the server 10 to update the latest on-site status for each inspection node 32, and the server 10 updates the verification checklist accordingly.
Step 4: Load historical records: Before inspection or verification, the client device 20 can load not only the location information of each inspection node 32 but also historical records of at least the last inspection/verification history for each node 32 to be inspected. Different inspection items may have different historical records for the nodes 32 to be inspected. For example, the historical records could include an expiration date of a fire extinguisher, the warranty period of a fire door, the location of a fire extinguisher, the power consumption of a motor, the carbon emissions of a vehicle, the usage of refrigerant, and so on.
Step 5: Determine inspection route. The server 10 calculates and generates an inspection route based on various factors such as the inspection requirements of each node 32 (e.g., scheduled inspection time, equipment replacement, environmental changes, parameter modifications, etc.), the location and attributes of each node 32, and optionally, the geographic location of the client device 20 (e.g., real-time location). The client device 20 can receive the inspection route and display the inspection route on the map. For example, the inspection route can be calculated based on the real-time geographic location of the client device 20, showing the shortest path that passes through the nodes 32 for inspection and verification. The map will display the locations and attributes of each node 32 along the inspection route.
Step 6: Provide directional guidance. The client device 20 obtains the user's geographical orientation, for example, using the electronic compass of the client device 20. The client device 20 compares the user's geographical orientation with the geographical orientation of the site 30 and displays a directional indicator on the map. The directional indicator can be represented by an arrow icon laid on the map. The arrow's direction corresponds to the user's geographical orientation as detected by the client device 20, and the arrow icon shows the user's current location on the map. This provides the user with visual guidance on the map based on the user's orientation.
Step 7: Obtain inspection/verification results and update the attributes. The client device 20 follows the inspection route and reaches each node 32. The client device 20 retrieves on-site status from the corresponding status report module of each node 32 and completes the inspection/verification process. Alternatively, the application on the client device 20 can display an attribute table on the user interface upon reaching each node 32. This allows the user to manually update the attributes by inputting information, taking photos (uploading photo files or using the device's camera for real-time capture), or uploading streaming messages. By doing so, the attributes of the node 32 to be inspected are updated, completing the inspection information update process.

Furthermore, after capturing real-time photos or periodically uploading real-time audiovisual information (such as photos or streaming data), a comparative identification method can be executed. This method identifies the differences between the historical audiovisual information and the real-time audiovisual information. The method also identifies the data, dimensions, and locations within the real-time audiovisual information. Based on this, the attribute table can mark the areas of change in the real-time audiovisual information and indicate the inspection/verification results (deviations and compliance). For example, based on the image recognition results from the photos, the method can determine if there are obstructions in the evacuation route, whether the dimensions comply with regulations, if fire doors are locked, and if the pressure gauge on a fire extinguisher meets safety standards. This allows for the identification of discrepancies and compliance based on the analysis of the captured images.

Furthermore, the client device 20 can generate messages based on whether the attributes of each node 32 meet certain criteria. For example, if the attribute “last inspection date” is reaching designated span of time, the client device 20 will produce various types of messages, including sound notifications and text messages, on the mobile device.

Based on the aforementioned descriptions, the present invention has the following features:
1. This invention offers a solution to overcome the challenges of relying solely on manual inspections/verifications, which often lead to potential oversights due to human limitations.
2. The inspection's effectiveness is enhanced by the auto-directing auditing system, enabling inspectors to easily update inspection information by following the map's directions and directly accessing the relevant nodes. This streamlined process eliminates guesswork and minimizes unnecessary effort.
3. The system enables proactive inspections, allowing users to autonomously update monitoring and inspection items at specific nodes. This capability empowers users to take control and actively manage inspections at designated locations.
4. The system provides real-time video monitoring, significantly enhancing the reliability of inspections. With the capability of real-time video surveillance, the credibility of inspections/verifications is greatly improved.
5. The system incorporates a date reminder function, preventing forgetfulness. With the date reminder feature, it helps avoid forgetting important dates and ensures timely actions.
6. The system offers the benefits of precise positioning and real-time updates of inspection/verification results, addressing the technical challenges of getting lost and lacking records during the entire inspection/verification process. It achieves the effectiveness of intelligent inspection and systematic updates, providing a solution for efficient and accurate inspections.

What is claimed is:

1. An auto-directing auditing system operated by a mobile device, comprising the following steps:
a server loads a map, wherein the map corresponds to a site awaiting auditing;
the mobile device obtains a current location and marks said current location on corresponding position on the map;
the server loads multiple nodes awaiting auditing in the site and marks the nodes on the map;
the server loads multiple historical records and multiple attributes of the nodes in the server; and
an inspection route is determined and generated based on audit requirements, wherein the inspection route passes through each node awaiting audit on the map.

2. The auto-directing auditing system according to claim 1, wherein the map is a three-dimensional map.

3. The auto-directing auditing system according to claim 1, wherein at least one of the nodes comprises a status report module in connection with the server, wherein the status report module establishes a connection with the mobile device when the mobile device is in proximity and the status report module updates the real-time location of the mobile device on the map.

4. The auto-directing auditing system according to claim 2, wherein at least one of the nodes comprises a status report module in connection with the server, wherein the status report module establishes a connection with the mobile device when the mobile device is in proximity and the status report module updates the real-time location of the mobile device on the map.

5. The auto-directing auditing system according to claim 3, wherein the mobile device generates a message based on whether the attributes satisfy a set of predefined conditions.

6. The auto-directing auditing system according to claim 5, wherein the set of predefined conditions comprises a last inspection date.

7. The auto-directing auditing system according to claim 3, wherein the mobile device obtains a geographic orientation of a user and compares the geographic orientation with the geographic orientation of the site, and a directional icon is displayed on the map, overlapping with the inspection route, wherein the directional icon indicates the orientation along the inspection route.

8. The auto-directing auditing system according to claim 4, wherein the mobile device obtains a geographic orientation of a user and compares the geographic orientation with the geographic orientation of the site, and a directional icon is displayed on the map, overlapping with the inspection route, wherein the directional icon indicates the orientation along the inspection route.
